(19) United States
(12) Patent Application Publication
(10) Pub. No.: US 2006/0082760 A1
(43) Pub. Date: Apr. 20, 2006

(54) Optical sensing module, optical sensing and image capturing architecture, and method for optically scanning fingerprints with a portable communications system

(75) Inventor: Chih-Neng Lin, Hsin-Tien City (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORP.

(21) Appl. No.: 11/213,814

(22) Filed: Aug. 30, 2005

(30) Foreign Application Priority Data
Oct. 15, 2004 (TW) 93131364

(51) Int. Cl. G06K 9/74

(52) U.S. Cl. 356/71

(57) ABSTRACT

An optical sensing module, an optical sensing and image capturing architecture, and a method for optically scanning fingerprints with a portable communications system are applied to a mobile phone to capture a group of images of a fingerprint on a finger of the user holding having the mobile phone. The optical sensing module has a light permeable device, at least one light source, and a sensing device. The sensing device has a plurality of sensors that form a line array of sensors. The optical sensing and image capturing architecture has the above optical sensing module and an image output unit. The volume of the optical sensing module is reduced for facilitating installation in the portable communications system, for fragmentally capturing a group of images of the fingerprint, and for processing of identification of the fingerprint.

### BACKGROUND OF THE INVENTION

1. Field of the Invention

The present invention relates to an optical sensing module, an optical sensing and image capturing architecture, and a method for optically scanning fingerprints with a portable communications system, and more particularly, to an optical sensing module that captures a group of images of a 3-D surface of a sensed object including a fingerprint, to an optical sensing and image capturing architecture that is small in size, and to a method for optically scanning fingerprints applied to a portable communications system for processing of identification of fingerprints.

2. Background of the Invention

Fingerprints are biological characteristics unique to each person and very useful as a set of personal secret codes. A fingerprint identification system captures a fingerprint image with an optical sensing module thereof, processes the fingerprint image, and then starts searching the fingerprint identification data in a database thereof for comparison of the fingerprint image. If the fingerprint image conforms to the fingerprint identification data in the database, the comparison is successful, thereby achieving the effect of personal identification. Therefore, the fingerprint identification system provides a high degree of safety for protection of secret codes for a user, and it is very suitable for application in the management and protection of personal information.

As industrial technology progresses, a portable communications system can store more and more data. For example, a mobile phone stores personal information including communications records, daily events, and so forth therein. Consequently, a mobile phone has secret code protection for protecting access to and use of the personal information therein. The secret code protection of mobile phones only allows four numbers for the secret codes. Secret codes are easily deciphered, rendering personal information vulnerable. Therefore, a mobile phone having a fingerprint identification system can achieve a high degree of safety for the secret code protection. A mobile phone, for example, can verify that a user's fingerprints are in fact the fingerprints of its owner, and subsequently grant access to the functions and information therein.

Referring to FIG. 1, a conventional optical sensing module applied to a fingerprint identification system of a mobile phone has a right-angled prism 80, a light source 81, a convergent lens 82, and a surface-type sensing device 83. The right-angled prism 80 has a light-in face 801, a reflection face 802, and a light-out face 803. The light source 81 is arranged adjacent to the light-in face 801. The convergent lens 82 and the surface-type sensing device 83 are arranged adjacent to the light-out face 803 in sequence. The entire fingerprint of a finger 9 is placed, at once, on the reflection face 802. The light of the light source 81 is projected into the light-in face 801 and transmitted to the reflection face 802, the fingerprint on the reflection face 802 reflects the light to the light-out face 803, and then the light is focused on the surface-type sensing device 83 by the convergent lens 82 and the size of the original whole fingerprint image is reduced.

The optical sensing module mentioned above has at least the following drawbacks. First of all, to obtain a complete fingerprint image, the whole fingerprint must be placed on the reflection face of the right-angled prism at the same time, requiring a large right-angled prism. The size of the original whole fingerprint image has to be reduced, causing a large depth of field D between the convergent lens and the surface-type sensing device. As a result, the volume of the whole optical sensing module is too large to applied in a miniaturized portable communications system, such as a mobile phone. Second, the assembly of the right-angled prism and the convergent lens has to have a precise position to ensure that the light path of the light source is correct. As a result, the assembly thereof is difficult and expensive. Furthermore, the size of the original whole fingerprint image is reduced via the convergent lens, distorting the image.

### SUMMARY OF INVENTION

The primary object of the invention is therefore to specify an optical sensing module, an optical sensing and image capturing architecture, and a method for optically scanning fingerprints with a portable communications system. The volume of the optical sensing module is thus reduced and the optical sensing module fragmentally captures a group of images of a 3-D surface of a sensed object for application to a portable communications system. The assembly of the optical sensing module is therefore simplified and cheaper, and the reliability and the stability of the optical quality of the optical sensing module are improved for enhancing the accuracy and the high degree of safety of the optical sensing and image capturing architecture of the portable communications system.

According to the invention, the object is achieved via an optical sensing module of a portable communications system for capturing a group of images of a 3-D surface of a sensed object. The optical sensing module comprises a light permeable device, at least one light source, and a sensing device. The light permeable device has a light-in face, a reflection face, and a light-out face. The at least one light source is arranged adjacent to the light-in face of the light permeable device. The sensing device is arranged adjacent to the light-out face of the light permeable device. The sensing device has a plurality of sensors forming a line array of sensors corresponding to the light-out face. The sensed object is movable and placed on the reflection face, the light of the at least one light source is projected into the light-in face and transmitted to the reflection face, the 3-D surface of the sensed object on the reflection face reflects the light to the light-out face, and the light is focused on the line array of sensors that fragmentally captures a group of images of the 3-D surface of the sensed object.

According to the invention, the object is achieved via an optical sensing and image capturing architecture of a portable communications system for capturing a group of images of a 3-D surface of a sensed object. The optical sensing and image capturing architecture comprises a light permeable device, at least one light source, a sensing device, and an image output unit. The sensing device has a plurality of sensors forming a line array of sensors. The sensed object is movable and placed on the light permeable device, the light of the at least one light source is projected into the light permeable device, the 3-D surface of the sensed object reflects the light, the light is focused on the line array of sensors that fragmentally captures a group of images of the 3-D surface of the sensed object to obtain a plurality of fragmental sensed images, and the image output unit integrates the fragmental sensed images into a serial or a parallel information form for output.

According to the invention, the object is achieved via a method for optically scanning fingerprints with a portable communications system. The method for optically scanning fingerprints with a portable communications system comprises providing an optical sensing module of a portable communications system and placing and moving a fingerprint on the optical sensing module. The optical sensing module includes a sensing device having a plurality of sensors forming a line array of sensors. The line array of sensors fragmentally captures a group of images of the fingerprint to obtain a plurality of fragmental images of the fingerprint.

The optical sensing module is formed with a light permeable device and a sensing device having a line array of sensors, so the volume thereof is small. Therefore, it is easily assembled and cheap. The optical sensing module is very suitable for installation into a miniaturized portable communications system including a mobile phone, such that the portable communications system has a fingerprint identification function.

The line array of sensors fragmentally captures a group of images of the 3-D surface of the sensed object, such that the area of each of the original fragmental images captured by the optical sensing module each time is small. Therefore, the depth of field between the light-out face and the line array of sensors is reduced, each of the fragmental sensed images has a size that is almost the same as that of each of the original fragmental images of the 3-D surface of the sensed object without distortion, and the reliability and the stability of the optical quality of the light permeable device are improved.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic planar view of an optical sensing module according to the prior art;

FIG. 2 is a schematic planar view of a first embodiment of an optical sensing module of a portable communications system according to the present invention;

FIG. 3 is a schematic planar view of a light permeable device and a light source of a first embodiment of an optical sensing module of a portable communications system according to the present invention;

FIG. 4 is a schematic view of a first embodiment of an optical sensing and image capturing architecture of a portable communications system according to the present invention;

FIG. 5 is a schematic view of a circuit of a first embodiment of an optical sensing and image capturing architecture of a portable communications system according to the present invention;

FIG. 6 is a schematic planar view of a light permeable device and a light source of a second embodiment of an optical sensing module of a portable communications system according to the present invention;

FIG. 7 is a schematic view of a second embodiment of an optical sensing and image capturing architecture of a portable communications system according to the present invention;

FIG. 8 is a schematic view of circuit of a second embodiment of an optical sensing and image capturing architecture of a portable communications system according to the present invention; and

FIG. 9 is a flow chart of a method for optically scanning fingerprints with a portable communications system according to the invention.

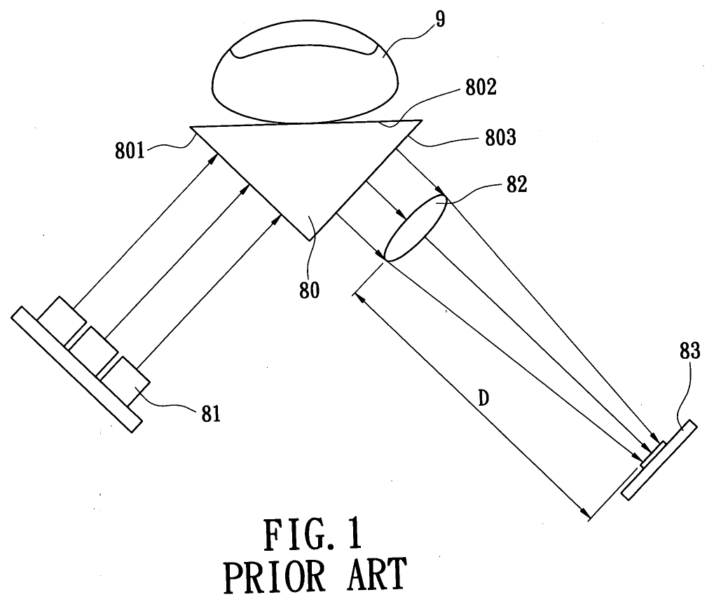

### DETAILED DESCRIPTION OF THE EMBODIMENTS

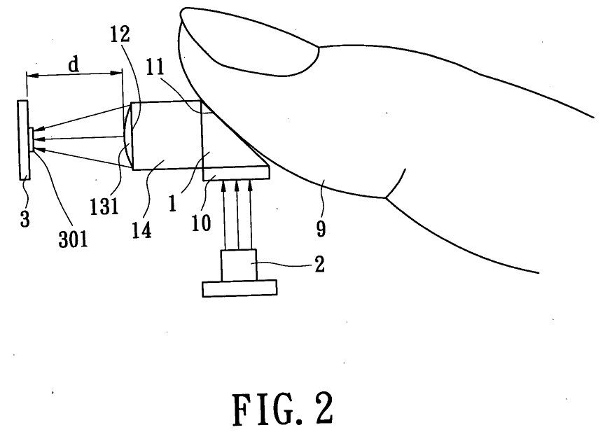

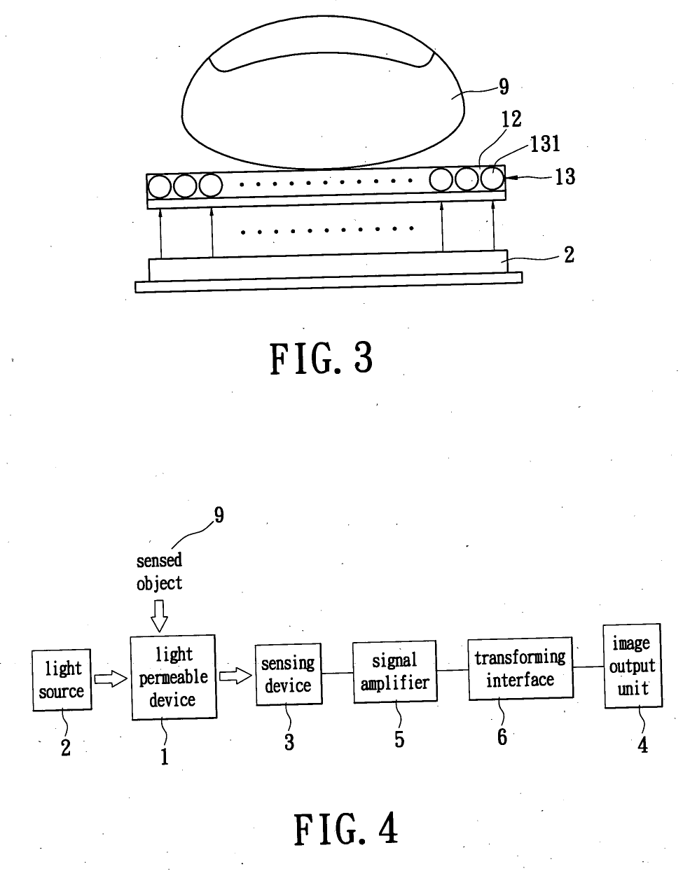

FIG. 2 and FIG. 3 show a first embodiment of an optical sensing module of a portable communications system according to the present invention. The present invention provides an optical sensing module of a portable communications system for capturing a group of images of a 3-D surface of a sensed object 9. For example, the optical sensing module is applied in a mobile phone for capturing a group of images of a fingerprint on a finger of the holder having the mobile phone. The portable communications system is, for example, a mobile phone or a personal digital assistant. The optical sensing module comprises a light permeable device 1, at least one light source 2, and a sensing device 3.

The light permeable device 1 has a light-in face 10, a reflection face 11, and a light-out face 12. The light permeable device 1 has a plurality of convergent lenses 131 disposed on the light-out face 12 and forming a line array of lenses 13. The light permeable device 1 may be a line-type prism, and the convergent lenses 131 are integrally formed on the light-out face 12 in one piece or assembled on the light-out face 12. In this embodiment, each of the convergent lenses 131 has a convex and round structure for providing a convergent effect. The light permeable device 1 further has an extension post 14 disposed between the reflection face 11 and the light-out face 12, so that the light through the light permeable device 1 is refracted two times to avoid light interference.

The at least one light source 2, such as an LED, is arranged adjacent to the light-in face 10 of the light permeable device 1.

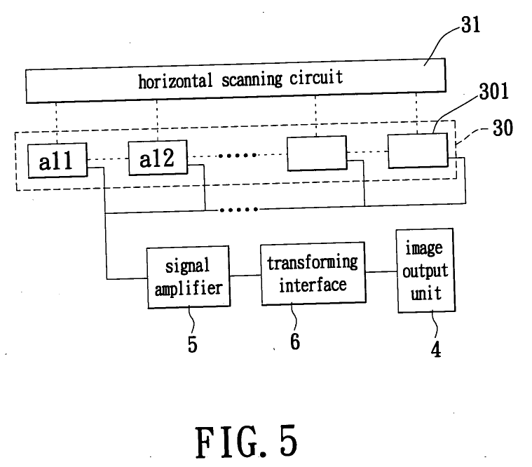

The sensing device 3 is arranged adjacent to the light-out face 12 of the light permeable device 1. The sensing device 3 has a plurality of sensors 301 forming a line array of sensors 30 (see FIG. 5) corresponding to the line array of lenses 13 on the light-out face 12. The line array of sensors 30 may be a 1×M 2-D array, and the number M is a positive integer. In this embodiment, the line array of sensors 30 is a 1×192 2-D array. Each of the sensors 301 has a width smaller than that of a convex ridge portion and that of a concave valley portion of the 3-D surface of the sensed object 9 (such as a width of a ridge portion and a width of a valley portion of a fingerprint). Each of the sensors 301 may have a width of 50.8 um, and the line array of sensors 30 may have an optical resolution of 500 dpi (dots per inch). The width of each of the sensors 301 and the optical resolution of the line array of sensors 30 may be embodied in different forms and should not be construed as being limited to the embodiment set forth herein. The quantity of the convergent lenses 131 of the light permeable device 1 depends on the demand thereof. For example, the quantity of the convergent lenses 131 of the light permeable device 1 and the quantity of the sensors 301 of the sensing device 3 may be one by two or one by one.

FIG. 4 and FIG. 5 show a first embodiment of an optical sensing and image capturing architecture of a portable communications system according to the present invention. The optical sensing and image capturing architecture is an application of the first embodiment of the optical sensing module mentioned above for capturing a group of images of a 3-D surface of a sensed object 9. For example, the optical sensing and image capturing architecture is applied in a mobile phone for capturing a group of images of a fingerprint on a finger of the user holding the mobile phone. The optical sensing and image capturing architecture comprises a light permeable device 1, at least one light source 2, a sensing device 3, and an image output unit 4.

The light permeable device 1, as mentioned above, has a plurality of convergent lenses 131 disposed on the light-out face 12 and forming a line array of lenses 13.

The at least one light source 2, as mentioned above, may be an LED.

The sensing device 3, as mentioned above, has a plurality of sensors 301 forming a line array of sensors 30. The light permeable device 1, the at least one light source 2, and the sensing device 3 form an optical sensing module of a portable communications system mentioned above.

The image output unit 4 is for integrating a plurality of fragmental sensed images into a serial or a parallel information form for output.

As shown in FIG. 2, the sensed object 9 is movable and placed on the reflection face 11 of the light permeable device 1 (for example, a fingerprint on a finger is placed on the reflection face 11 and is moved downwardly.) The light of the at least one light source 2 is projected into the light-in face 10 of the light permeable device 1 and transmitted to the reflection face 11. The 3-D surface of the sensed object 9 (for example, a fingerprint on a finger) on the reflection face 11 reflects the light to the line array of lenses 13 on the light-out face 12, and the light is focused on the line array of sensors 30 by the line array of lenses 13. The result of light reflected by ridge portions of the fingerprint is different from the result of light reflected by valley portions of the fingerprint. When light is transmitted in the prism and projected to a region of the reflection face 11 on which a ridge portion of the fingerprint is placed, it is scattered. When light is transmitted in the prism and projected to a region of the reflection face 11 on which a valley portion of the fingerprint is placed, it is totally reflected. In this manner, the sensors 301 sense different signals. Therefore, the line array of sensors 30 captures a part of the image of the 3-D surface of the sensed object 9 (for example, a part of the image of the fingerprint.) Meanwhile, when the sensed object 9 is moved, the line array of sensors 30 fragmentally captures a part of the image of the 3-D surface of the sensed object 9 to obtain a plurality of fragmental sensed images. The area of each of the original fragmental images of the sensed object 9 captured by the optical sensing module each time is small. Therefore, the depth of field d between the line array of lenses 13 on the light-out face 12 and the line array of sensors 30 is reduced, and each of the fragmental sensed images has a size that is almost the same as that of each of the original fragmental images of the 3-D surface of the sensed object 9 without distortion. Consequently, the volume of the optical sensing module is small and the cost thereof is reduced. Furthermore, it is easy to assemble the light permeable device 1, so the cost thereof is reduced and the reliability and the stability of the optical quality thereof are improved.

Referring to FIG. 5, the sensing device 3 includes a horizontal scanning circuit 31 for controlling analog signals of the fragmental sensed images for output. For example, the fragmental sensed images (such as a11, a12, and so on) are output in sequence.

The optical sensing and image capturing architecture further comprises a signal amplifier 5 and a transforming interface 6. The signal amplifier 5 is for amplifying analog signals of the fragmental sensed images. The transforming interface 6 is for transforming the analog signals into digital signals for the image output unit 4. The image output unit 4 integrates the fragmental sensed images into a serial or a parallel information form for output.

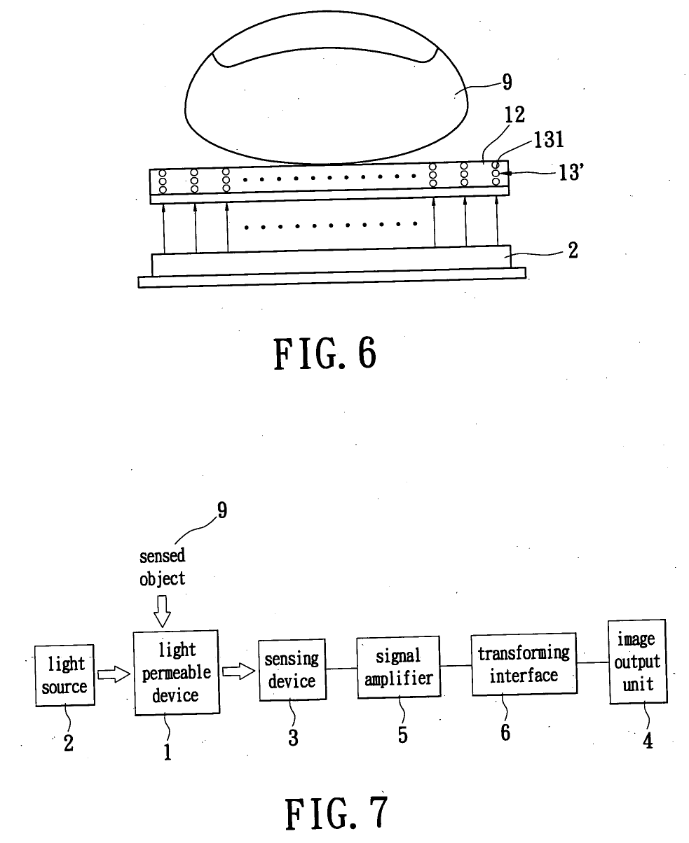

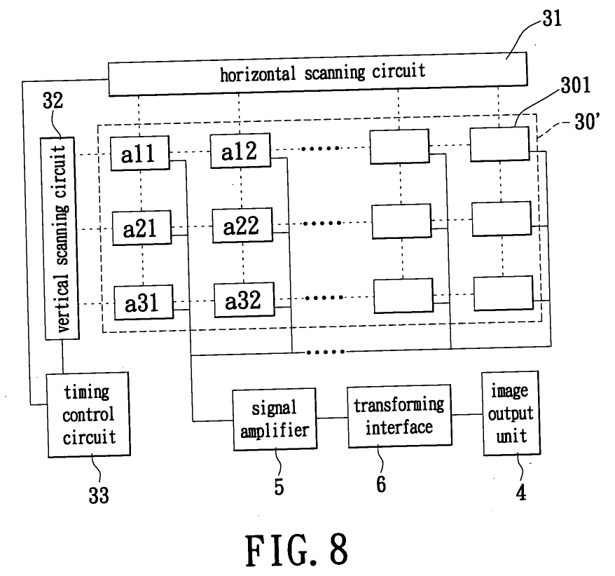

FIG. 6 shows a second embodiment of an optical sensing module of a portable communications system according to the present invention. The differences between the second embodiment and the first embodiment of the optical sensing modules are the line array of sensors 30′ of the sensing device 3 (see FIG. 8) and the line array of lenses 13′ of the light permeable device 1. The line array of sensors 30′ is an N×M 2-D array. The number N and the number M are positive integers, and the 2-D array has an area smaller than that of the 3-D surface of the sensed object 9. In the second embodiment, the line array of sensors 30′ is a 3×192 2-D array, and the line array of lenses 13′ is also a 3×192 2-D array.

FIG. 7 and FIG. 8 show a second embodiment of an optical sensing and image capturing architecture of a portable communications system according to the present invention. The optical sensing and image capturing architecture is an application of the second embodiment of the optical sensing module mentioned above. The differences between the second embodiment and the first embodiment of the optical sensing and image capturing architecture are sensing device 3 and the light permeable device 1 of the optical sensing module. The line array of sensors 30′ of the sensing device 3 and the line array of lenses 13′ of the light permeable device 1 are the same as those of the second embodiment of the optical sensing module. The sensing device 3 includes a horizontal scanning circuit 31, a vertical scanning circuit 32, and a timing control circuit 33 for controlling analog signals of the fragmental sensed images for output. For example, the fragmental sensed images (such as a11, a21, a31, a12, a22, a32, and so on) are output in sequence. The line array of sensors 30′ continuously and repeatedly senses the sensed object 9 to capture a great quantity of fragmental sensed images at different times. Then the signal amplifier 5 amplifies analog signals of the fragmental sensed images, the transforming interface 6 transforms the analog signals into digital signals for the image output unit 4, and the image output unit 4 integrates the fragmental sensed images into a serial or a parallel information form for output. The size of the line array of sensors 30′ can be changed according to the demand thereof. For example, the size of the line array of sensors 30′ can be an 8×192 2-D array, but this is not to be construed as a limitation upon the present invention. Because the quantity of the sensors 301 of the line array of sensors 30′ is less than that of the surface-type sensing device of the prior art, the volume of the sensing device 3 is small and the cost thereof is reduced.

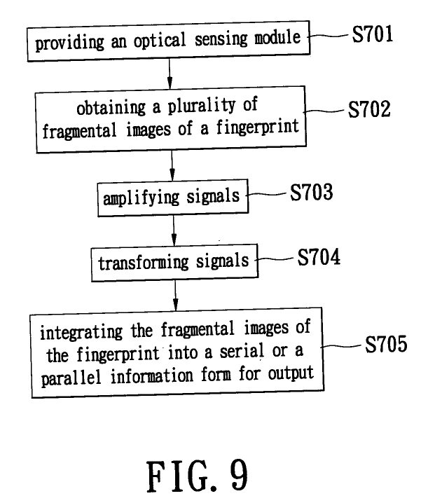

Referring to FIG. 9, and also referring to FIGS. 2-8, the present invention provides a method for optically scanning fingerprints with a portable communications system. The portable communications system is, for example, a mobile phone or a personal digital assistant.

An optical sensing module of a portable communications system is provided (S701). As mentioned in the first embodiment and the second embodiment of the optical sensing modules, the optical sensing module includes a light permeable device 1, at least one light source 2, and a sensing device 3. The light permeable device 1 forms a line array of lenses 13, 13′. The sensing device 3 has a plurality of sensors 301 forming a line array of sensors 30, 30′.

A fingerprint is placed and moved on the optical sensing module. The line array of sensors 30, 30′ fragmentally captures a group of images of the fingerprint to obtain a plurality of fragmental images of the fingerprint (S702). The fingerprint is placed and moved on the light permeable device 1, the light of the at least one light source 2 is projected into the light permeable device 1, the fingerprint reflects the light, and the light is focused on the line array of sensors 30, 30′ to obtain the fragmental images of the fingerprint.

In addition, a signal amplifier 5, a transforming interface 6, and an image output unit 4 are further provided. The signal amplifier 5 is for amplifying analog signals of the fragmental images of the fingerprint (S703), the transforming interface 6 is for transforming the analog signals into digital signals to the image output unit 4 (S704), and the image output unit 4 is for integrating the fragmental images of the fingerprint into a serial or a parallel information form for output (S705).

As indicated above, the optical sensing module, the optical sensing and image capturing architecture, and the method for optically scanning fingerprints with a portable communications system of the present invention have the following advantages:

(1) The optical sensing module is formed with the light permeable device and the sensing device having a line array of sensors, so the volume thereof is small. Therefore, it is easily and cheaply assembled. The optical sensing module is very suitable for installation in a miniaturized portable communications system such as a mobile phone, thus equipping the portable communications system with a fingerprint identification function.

(2) The line array of sensors fragmentally captures a group of images of the 3-D surface of the sensed object, such that the area of each of the original fragmental images captured by the optical sensing module each time is small. Therefore, the depth of field between the light-out face and the line array of sensors is reduced, each of the fragmental sensed images has a size that is almost the same as that of each of the original fragmental images of the 3-D surface of the sensed object without distortion, and the reliability and the stability of the optical quality of the light permeable device are improved.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An optical sensing module of a portable communications system for capturing a group of images of a 3-D surface of a sensed object, comprising:
a light permeable device having a light-in face, a reflection face, and a light-out face;
at least one light source arranged adjacent to the light-in face of the light permeable device; and
a sensing device arranged adjacent to the light-out face of the light permeable device, the sensing device having a plurality of sensors forming a line array of sensors corresponding to the light-out face; wherein
the sensed object is movable and placed on the reflection face, light of the at least one light source is projected into the light-in face and transmitted to the reflection face, the 3-D surface of the sensed object on the reflection face reflects light to the light-out face, and light is focused on the line array of sensors, wherein the line array of sensors fragmentally captures a group of images of the 3-D surface of the sensed object.

2. The optical sensing module as claimed in claim 1, wherein the portable communications system is a mobile phone or a personal digital assistant.

3. The optical sensing module as claimed in claim 1, wherein the sensed object includes a fingerprint.

4. The optical sensing module as claimed in claim 1, wherein the light permeable device has a plurality of convergent lenses disposed on the light-out face and forming a line array of lenses.

5. The optical sensing module as claimed in claim 4, wherein the light permeable device is a line-type prism, and the convergent lenses are integrally formed on the light-out face in one piece.

6. The optical sensing module as claimed in claim 4, wherein the light permeable device is a line-type prism, and the convergent lenses are assembled on the light-out face.

7. The optical sensing module as claimed in claim 1, wherein the line array of sensors is a 1×M 2-D array, and the number M is a positive integer.

8. The optical sensing module as claimed in claim 1, wherein the line array of sensors is a 1×192 2-D array.

9. The optical sensing module as claimed in claim 1, wherein the line array of sensors is an N×M 2-D array, the number N and the number M are positive integers, and the 2-D array has an area smaller than that of the 3-D surface of the sensed object.

10. The optical sensing module as claimed in claim 1, wherein the line array of sensors is a 3×192 2-D array.

11. The optical sensing module as claimed in claim 1, wherein each of the sensors has a width smaller than that of a ridge portion and that of a valley portion of the 3-D surface of the sensed object.

12. An optical sensing and image capturing architecture of a portable communications system for capturing a group of images of a 3-D surface of a sensed object, comprising:
a light permeable device;
at least one light source;
a sensing device having a plurality of sensors forming a line array of sensors; and
an image output unit; wherein
the sensed object is movable and placed on the light permeable device, light of the at least one light source is projected into the light permeable device, the 3-D surface of the sensed object reflects light, light is focused on the line array of sensors that fragmentally captures a group of images of the 3-D surface of the sensed object to obtain a plurality of fragmental sensed images, and the image output unit integrates the fragmental sensed images into a serial or a parallel information form for output.

13. The optical sensing and image capturing architecture as claimed in claim 12, wherein the line array of sensors is a 1×M 2-D array, the number M is a positive integer, and the sensing device includes a horizontal scanning circuit for controlling analog signals of the fragmental sensed images for output.

14. The optical sensing and image capturing architecture as claimed in claim 12, wherein the line array of sensors is an N×M 2-D array, the number N and the number M are positive integers, and the sensing device includes a horizontal scanning circuit, a vertical scanning circuit, and a timing control circuit for controlling analog signals of the fragmental sensed images for output.

15. The optical sensing and image capturing architecture as claimed in claim 12, comprising a signal amplifier for amplifying analog signals of the fragmental sensed images.

16. The optical sensing and image capturing architecture as claimed in claim 15, comprising a transforming interface for transforming the analog signals into digital signals to the image output unit.

17. A method for optically scanning fingerprints with a portable communications system, comprising:
providing an optical sensing module of a portable communications system, wherein the optical sensing module includes a sensing device having a plurality of sensors forming a line array of sensors; and
placing and moving a fingerprint on the optical sensing module, wherein the line array of sensors fragmentally captures a group of images of the fingerprint to obtain a plurality of fragmental images of the fingerprint.

18. The method for optically scanning fingerprints as claimed in claim 17, wherein the optical sensing module includes a light permeable device and at least one light source, the fingerprint is placed and moved on the light permeable device, light of the at least one light source is projected into the light permeable device, the fingerprint reflects light, and light is focused on the line array of sensors to obtain a plurality of fragmental images of the fingerprint.

19. The method for optically scanning fingerprints as claimed in claim 17, further comprising providing a signal amplifier, a transforming interface, and an image output unit, wherein the signal amplifier amplifies analog signals of the fragmental images of the fingerprint, the transforming interface transforms the analog signals into digital signals to the image output unit, and the image output unit integrates the fragmental images of the fingerprint into a serial or a parallel information form for output.
